(19) United States
(12) Patent Application Publication
(10) Pub. No.: US 2026/0241574 A1
(43) Pub. Date: Aug. 20, 2026

(54) WORK PROCESS SUPPORT SYSTEM AND WORK PROCESS SUPPORT METHOD

(71) Applicant: HITACHI, LTD., Tokyo (JP)

(72) Inventors: Kazushi YAMASHINA, Tokyo (JP); Yusuke OMURA, Tokyo (JP)

(21) Appl. No.: 19/159,421

(22) PCT Filed: Feb. 2, 2024
(86) PCT No.: PCT/JP2024/003534

§ 371 Date: Aug. 25, 2025

(30) Foreign Application Priority Data
Mar. 10, 2023 (JP) 2023-037564

(51) Int. Cl. B25J 9/16; B25J 13/06; G06V 10/70; G06V 20/50

(52) U.S. Cl. CPC B25J 9/1697; B25J 13/06; G06V 10/87; G06V 20/50

(57) ABSTRACT

To improve the efficiency with which a robot is controlled, the present invention is characterized by comprising a recognition unit that acquires work site information that is information about a work site for the robot and work object information that is information about a work object, an association definition unit that, upon generation of a work process for the robot, associates the work process with the work site information and the work object information, an image processing configuration unit that, on the basis of the association by the association definition unit, determines a configuration for image processing for the robot and calculates a computation amount for the image processing, and a processing optimization unit that, on the basis of the computation amount and a priority selected by a user, determines an allocation to computational resources with respect to the image processing and outputs the results of the allocation.

### TECHNICAL FIELD

The present invention relates to a technique for a work process support system and a work process support method.

### BACKGROUND ART

As one aspect of recent demand for robots, the development of a remote controlled robot that is operated by a person is progressing. Generally, it is difficult to operate the remote controlled robot (hereafter referred to as a robot), and it is necessary to improve operational skills of the person. If the robot control side can provide operational support, such as correction of the position of a human operation and displaying of a work spot, the difficulty of operation may decrease and work efficiency using the robot may be improved. Meanwhile, to provide such operational support, the robot needs to grasp a series of work operations in advance and needs a program to handle image recognition and control processing relating to the work operations. Preparing this for each work operation requires a lot of development time and lacks versatility. In remote operation, operability generally degrades if a robot's response to an operation by a person is delayed.

Therefore, it is necessary to provide means for ensuring performance by automatically constructing a configuration of robot control processing from a procedure for target work in advance, while ensuring that the control processing does not result in a delay in robot control.

For example, Patent Literature 1 discloses a design support apparatus, a design support method, and a design support program (see Abstract), and “the design support apparatus includes a reception unit that receives sequence constraints for each work operation, work operation time for each work operation, and whether or not each work operation is allowed to be performed by a robot for a product that requires multiple work operations for assembly; a first index calculation unit that calculates, as a first index for each work operation that is not allowed to be performed by the robot, the number of consecutive work operations that are performed by the robot when the work operations are allowed to be performed by the robot based on the sequence constraints and whether or not each work operation is allowed to be performed by the robot; a second index calculation unit that calculates, as a second index for each work operation that is not allowed to be performed by the robot, a degree of freedom of placement when the work operations are allowed to be performed by the robot based on the sequence constraints, the work operation time, and whether the work operations are allowed to be performed by the robot; and a presentation unit that presents information based on the first index and the second index, and target work operations of the first index and the second index in association with each other.

### CITATION LIST

### Patent Literature

Patent Literature 1: Japanese Unexamined Patent Application Publication No. 2019-016165

### SUMMARY OF INVENTION

### Technical Problem

As described above, the technique described in Patent Literature 1 is a technique relating to the arrangement of a robot in a work process and improves the work efficiency of the robot as a collective body. However, the technique described in Patent Literature 1 does not optimize the efficiency of controlling each robot.

The present invention has been made in view of the above-described circumstances, and an object of the present invention is to improve the efficiency of controlling a robot.

### Solution to Problem

To solve the above-described problem, the present invention includes a recognition unit that acquires work location information that is information regarding a work location of a robot and work object information that is information of a work object; an association definition unit that, when a work process of the robot is created, associates the work process with the work location information and the work object information; a control processing configuration unit that determines a configuration of control processing for the robot based on the association by the association definition unit and calculates a computation amount in the control processing; and a processing optimization unit that determines, based on the computation amount and a priority item selected by a user, assignment of processing to a computing resource for processing to be performed in the work process and outputs a result of the assignment.

Other solutions will be described in embodiments as appropriate.

### Advantageous Effects of Invention

According to the present invention, it is possible to improve the efficiency of controlling a robot.

### BRIEF DESCRIPTION OF DRAWINGS

FIG. 1 is a diagram illustrating an example of a configuration of a robot operation system.

FIG. 2 is a diagram illustrating an example of a configuration of computing sources in a controller.

FIG. 3 is a diagram illustrating a GUI screen for operating the robot operation system.

FIG. 4 is a functional block diagram of the controller.

FIG. 5 is a flowchart illustrating a process procedure of a work process support method according to the present embodiment.

FIG. 6 is a diagram illustrating an example of a work location registration screen.

FIG. 7 is a diagram illustrating an example of work location information.

FIG. 8 is a diagram illustrating an example of a work object registration screen.

FIG. 9 is a diagram illustrating an example of work object information.

FIG. 10 is a diagram illustrating an example of operation information.

FIG. 11 is a diagram illustrating an example of work process information.

FIG. 12 is a diagram illustrating image processing configuration information.

FIG. 13 is a diagram illustrating an example of a result of computation mapping in a case where “performance” is selected as an optimization option.

FIG. 14 is a diagram illustrating an example of a result of computation mapping in a case where “resource” is selected as the optimization option.

FIG. 15 is a diagram illustrating an example of a result of computation mapping in a case where “real-time performance” is selected as the optimization option.

FIG. 16 is a diagram illustrating an example of a result of computation mapping according to a second embodiment.

### DESCRIPTION OF EMBODIMENTS

Next, embodiments of the present invention (hereinafter referred to as “embodiments”) will be described with reference to the drawings as appropriate.

### First Embodiment

(Robot Operation System Z)

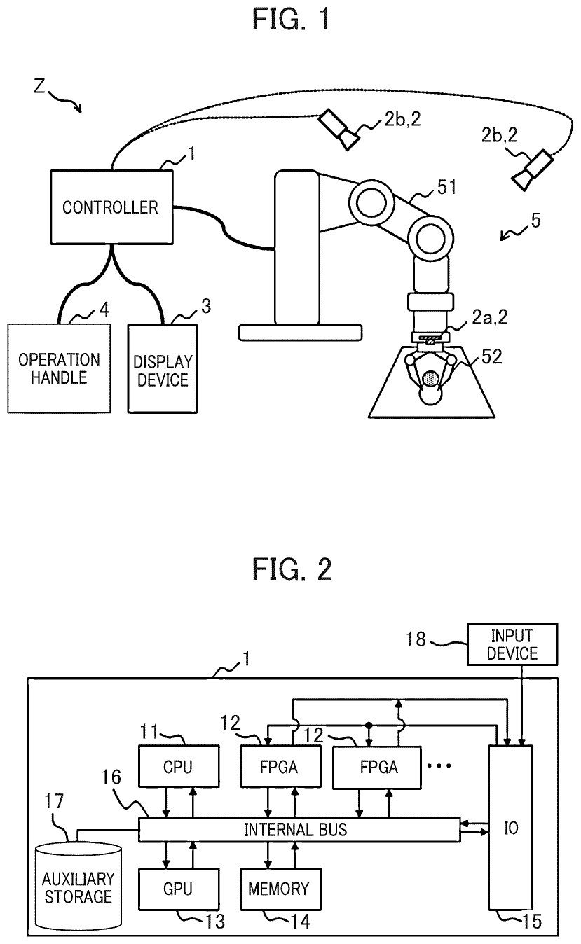

FIG. 1 is a diagram illustrating an example of a configuration of a robot operation system Z.

The robot operation system Z that is a work process support system includes a controller 1, an operation handle 4, a display device 3, a camera 2, and a robot 5. The robot 5 includes a robot hand 52 and a robot arm 51 that are components. The robot hand 52 grips a work object such as a component, and the robot arm 51 moves the robot hand 52. In the present embodiment, the robot 5 in which one end of the robot arm 51 is fixed is described. However, the present embodiment is not limited thereto. For example, the present embodiment may be applied to a movable robot that the robot is provided with legs, wheels, or the like.

The controller 1 controls the robot arm 51 and the robot hand 52. The operation handle 4 is used for a user to operate the robot arm 51 and the robot hand 52. That is, the controller 1 transmits a control signal to the robot hand 52 and the robot arm 51 based on an operation of the operation handle 4 by the user to remotely control the robot hand 52 and the robot arm 51. As described above, the robot arm 51 and the robot hand 52 operate based on an input via the operation handle 4. The camera 2 that is an imaging device includes a camera 2a and a camera 2b. The camera 2a is the camera 2 included in the robot hand 52 to capture an image of a work spot when the robot 5 works. The camera 2b is the camera 2 installed at a location where it can take bird's-eye views of the entire robot 5 and a work location and capture images of the entire robot 5 and the work location. The camera 2b is movable and can change an imaging range.

The display device 3 displays the images captured (images) by the camera 2. In a case where the user operates the robot 5, the images captured by the camera 2 are displayed on the display device 3. The user operates the operation handle 4 to operate the robot 5, while viewing the images displayed on the display device 3. In the present embodiment, it is assumed that the camera 2 captures video and that the images are video images.

### (Controller 1)

FIG. 2 is a diagram illustrating an example of a configuration of computing sources in the controller 1.

The controller 1 is constituted by a personal computer (PC) or the like and includes a CPU 11, a plurality of FPGAS 12, a GPU 13, a memory 14, an IO 15, and an auxiliary storage 17. The CPU 11, the FPGAs 12, the GPU 13, the memory 14, the IO 15, and the auxiliary storage 17 are connected to an internal bus 16. The CPU 11, the FPGAS 12, and the GPU 13 may be appropriately referred to as computing devices. The CPU is an abbreviation for Central Processing Unit. The FPGA is an abbreviation for Field Programmable Gate Array. The GPU is an abbreviation for Graphics Processing Unit. The IO is an abbreviation for Input/Output. The auxiliary storage 17 is constituted by a hard disk (HD), a solid state drive (SSD), or the like. Thus, in recent years, with the improvement of semiconductor packaging technology, controllers 1 having heterogeneous computing resource configurations as illustrated in FIG. 2 is increasing in number, rather than being equipped with only the commonly used general-purpose CPU 11. Therefore, in the present embodiment, it is assumed that the robot operation system Z supports the controller 1 having such a heterogeneous computing resource configuration.

In addition, an input device 18 such as a keyboard, a mouse, or the like is connected to the controller 1 via the IO 15.

The CPU 11 includes multiple cores and can execute a plurality of threads. The FPGAs 12 are connected to the CPU 11, the GPU 13, the memory 14, the IO 15, and the auxiliary storage 17 via the internal bus 16, and can directly transmit and receive information to and from the IO 15.

In the present embodiment, an example in which the CPU 11 and the FPGAs 12 are used as computing devices that perform processing is described, but as computing devices that perform processing, a combination of the CPU 11 and the GPU 13 or a combination of the CPU 11, the FPGAS 12, and the GPU 13 may be used.

### (GUI Screen D)

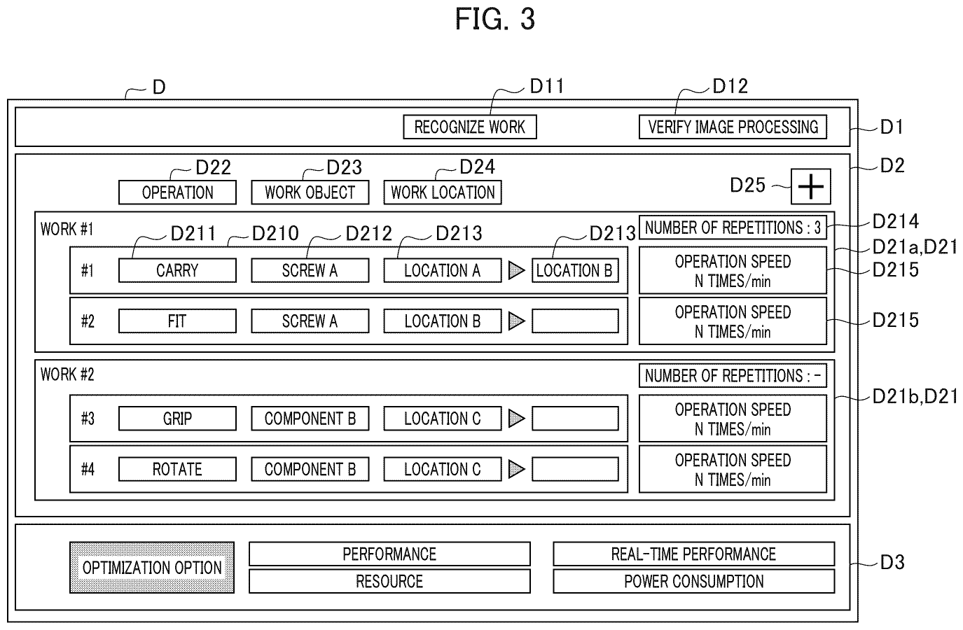

FIG. 3 is a diagram illustrating a graphical user interface (GUI) screen D for operating the robot operation system Z.

The GUI screen D that is a user interface is a screen displayed on the display device 3 illustrated in FIG. 1, and includes a utility region D1, a work process edit region D2, and a processing mode edit region D3. Due to the GUI screen D, the user can visually operate the robot operation system Z. Then, the user operates the GUI screen D to set a series of operations to be performed by the robot 5 and create a work process of the robot 5.

A configuration of the GUI screen D will be described below. Detailed description of each configuration of the GUI screen D will be given later.

The utility region D1 includes a recognize work button D11 and a verify image processing button D12. The recognize work button D11 is pressed to execute pre-recognition registration required to create the work process of the robot 5 in the robot operation system Z. A work definition region D21 collectively defines a series of control operations to be performed by the robot 5. The verify image processing button D12 is pressed to start verifying a configuration for image processing and an execution method for processing of each type. As described above, in a case where the user operates the robot 5, the user operates the robot 5 while visually recognizing the images captured by the camera 2 with the display device 3. The image processing is part of processing constituting control processing for the robot 5 and is performed to make the images easily recognizable by the user when the operation of the robot 5 is performed. That is, the control processing includes the image processing of processing the images input from the camera 2.

In the work process edit region D2, the work process to be performed by the robot 5 is settable. In the work process edit region D2, the user can visually rearrange the work definition region D21 that is a process of a work operation by the robot 5, or the like. In the work definition region D21, an operation unit setting region D210 that is an operation unit constituting the work process is displayed by the user. In the operation unit setting regions D210, the user can perform setting. In the work definition region D21, one or more operation unit setting regions D210 are set. As described above, the operation unit setting region D210 that is an operation unit is a minimum control unit in the work process of the robot 5 and can be specified by the user. The robot 5 sequentially performs a work operation set in the operation unit setting region D210 for each work definition region D21.

Each operation unit setting region D210 includes each of elements of an operation content display region D211, a work object display region D212, and a work location display region D213. In the operation content display region D211, an operation that is performed by the robot 5 is set by the user. In the work object display region D212, a work object targeted in the operation content display region D211, that is, a work object that is an object on which the robot 5 performs an operation, is set. The work object is, for example, a component or the like of a product to be assembled by the robot 5. In the work location display region D213, a location where the robot 5 works, that is, a location where the robot 5 performs the operation, is set.

Each operation content display region D211 is set by the user pressing an operation button D22 via the input device 18. Similarly, each of the work object display region D212 and the work location display region D213 is set by the user pressing a work object button D23 and a work location button D24 via the input device 18, respectively.

Settings of the operation content display region D211, the work object display region D212, and the work location display region D213 will be described later.

In the work process edit region D2, an add button D25 for adding a work definition region D21 is displayed. In the work definition region D21, a number-of-repetitions setting region D214 and an operation speed setting region D215 are displayed.

In the number-of-repetitions setting region D214, the number of=repetitions of the operation corresponding to the operation unit setting region D210 displayed in the work definition region D21 is set. As described above, in the number-of-times setting region D214, the number of repetitions of the work process set in the work definition region D21 can be set by the user. In the operation speed setting region D215, the operation speed at which the robot 5 performs the operation and that is indicated in the corresponding operation unit setting region D210 is settable. The operation speed is the number of control operations that are performed by the robot 5 per unit of time.

When the user performs the image processing, it is possible to select which of items such as the computing resource configuration of the controller 1 and the control performance required for the robot 5 needs to be given priority (selection of a priority item) in the processing mode edit region D3. That is, in the processing mode edit region D3, the user can set which of the computing resource configuration such as resources and the control performance such as performance is to be given top priority for execution of the image processing. As described above, by setting in the processing mode edit region D3, an execution mode of the image processing in the controller 1 is set.

### (Controller 1)

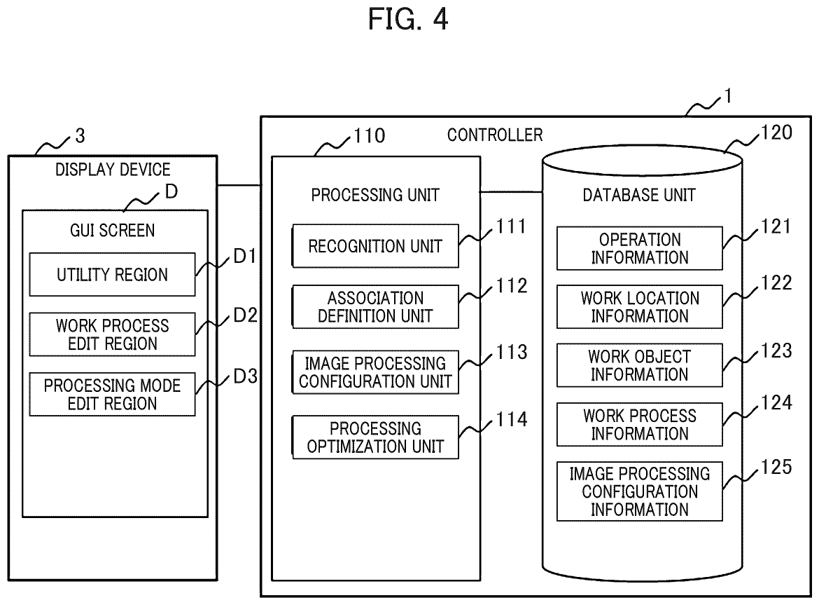

FIG. 4 is a functional block diagram of the controller 1. In FIG. 4, with reference to FIGS. 1 to 3 as appropriate, the components illustrated in FIGS. 2 and 3 are denoted by the same reference signs and description thereof is omitted.

The controller 1 includes a processing unit 110 and a database unit 120 that is a storage unit. As illustrated in FIG. 1, the controller 1 is connected to the display device 3 on which the GUI screen D illustrated in FIG. 3 is displayed. In the GUI screen D displayed on the display device 3, the regions from the utility region D1 to the processing mode edit region D3 illustrated in FIG. 3 are displayed.

The processing unit 110 includes various functions that are executed in the background when various operations of the GUI screen D are performed. The processing unit 110 includes a recognition unit 111, an association definition unit 112, an image processing configuration unit 113, and a processing optimization unit 114.

The recognition unit 111 recognizes the work location and the work object. Therefore, the recognition unit 111 acquires work location information 122 that is information regarding the work location of the robot 5 and work object information 123 that is information of the work object.

When the work process of the robot 5 is created, the association definition unit 112 associates the work process with the work location information 122 and the work object information 123. Specifically, the association definition unit 112 stores, to work process information 124, information in which the content set in the work process edit region D2 of the GUI screen D is associated with the work location information 122 and the work object information 123.

The image processing configuration unit 113 that is a control processing configuration unit determines a configuration for the control processing for the robot 5 based on the association by the association definition unit 112 and calculates a computation amount in the control processing. In the present embodiment, it is assumed that the image processing is performed as the control processing for the robot 5. That is, the image processing configuration unit 113 determines, based on the information of the work process information 124, processing necessary for image correction processing, an image recognition algorithm, and the computation amount, and stores the determined information to image processing configuration information 125. Although the image correction processing is described later, the image correction processing is processing constituting the image processing and is “noise reduction”, “contrast enhancement”, “edge enhancement”, and the like. That is, in the present embodiment, the image processing is constituted by the image correction processing and recognition processing by the image recognition algorithm.

The processing optimization unit 114 determines assignment to computing resources for the image processing based on the computation amount and a priority item selected by the user and outputs a result of the assignment. That is, the processing optimization unit 114 assigns the processing of each type to the computing resources for processing to be performed in the image processing based on the image processing configuration information 125 and performs computation mapping for determining a time schedule.

A program stored in the auxiliary storage 17 illustrated in FIG. 2 is loaded into the memory 14. The loaded program is executed by the CPU 11. This implements the units from the recognition unit 111 to the processing optimization unit 114.

The database unit 120 is a storage region for storing data to be processed by the processing unit 110. The database unit 120 corresponds to the auxiliary storage 17 illustrated in FIG. 2, but another database server (not illustrated) other than a computer may be provided.

The database unit 120 includes operation information 121, the work location information 122, the work object information 123, the work process information 124, and the image processing configuration information 125.

In the operation information 121, information indicating whether the robot arm 51 operates in response to an operation and whether the robot hand 52 operates is stored for an operation.

In the work location information 122, information regarding the work location of the robot 5 is stored.

In the work object information 123, information of the work object that is an object that the robot 5 works is stored.

In the work process information 124, information in which the content set in the work process edit region D2 of the GUI screen D is associated with the work location information 122 and the work object information 123 is stored.

In the image processing configuration information 125, information created based on the work process information 124 and indicating the processing of each type to be performed in the image correction processing, the image recognition algorithm, the computation amount, and the like are stored.

The controller 1 according to the present embodiment has a function of controlling the robot 5 and a function of supporting the control of the robot 5. However, the present embodiment is not limited thereto. An apparatus that supports the control of the robot 5 may be provided separately from the controller 1 that supports the control of the robot 5.

### [Process]

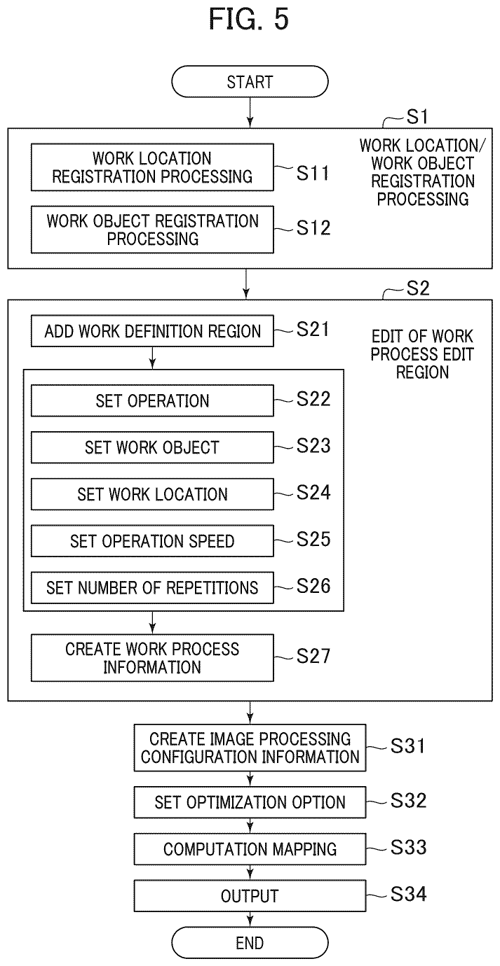

Next, a procedure of a process that is performed in the robot operation system Z according to the present embodiment will be described with reference to FIGS. 5 to 15. In the following description, step numbers are step numbers illustrated in FIG. 5. FIGS. 1 and 2 are referenced as appropriate.

As described above, when the user operates the robot 5, the user visually recognizes the work object to be handled in a work operation via the display device 3 in addition to the robot hand 52 and the robot arm 51 in general. In addition, operations are performed in which the robot hand 52 grips the work object and moves the work object to any location or the robot hand 52 processes the work object while gripping the work object. In this case, depending on a work situation, the background color and brightness visually recognized on the display device 3, the characteristics of the work object, and the viewpoint that the user wants to focus on change from moment to moment depending on each work operation. The purpose of the robot operation system Z according to the present embodiment is to improve the visibility of the working status of the robot 5 drawn on the display device 3 and to enable correction of the operation of the robot.

FIG. 5 is a flowchart illustrating a process procedure of a work process support method according to the present embodiment.

### <S1: Work Location/Work Object Registration Processing: Recognition Step>

First, the user presses the recognize work button D11 displayed on the GUI screen D to execute recognition registration necessary for creating the work process. As illustrated in FIG. 5, work location/work object registration processing includes work location registration processing (S11) and work object registration processing (S12). In FIG. 5, processing that is not connected by an arrow indicates that the order of processing is not fixed within a processing frame to which the processing belongs.

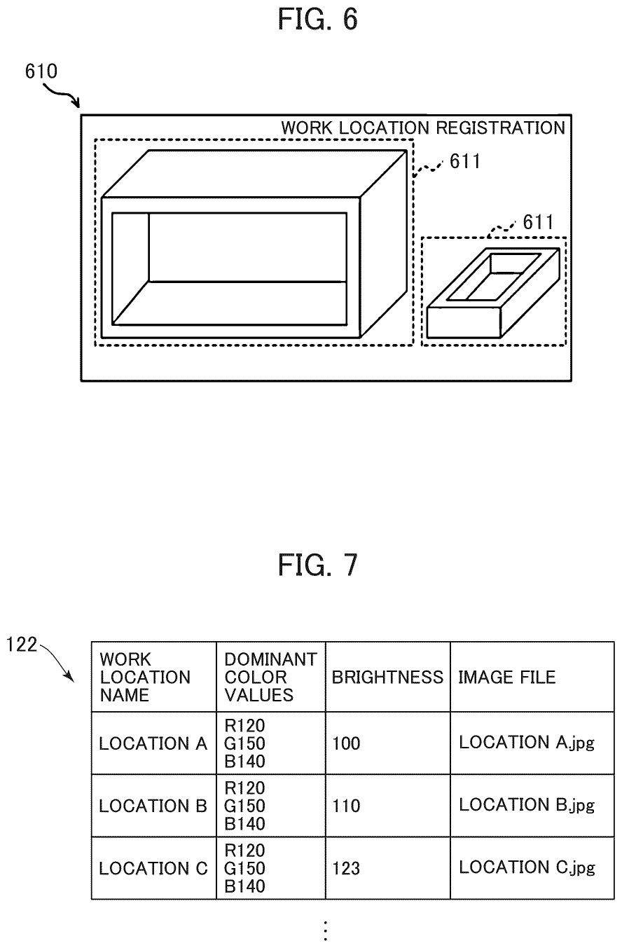

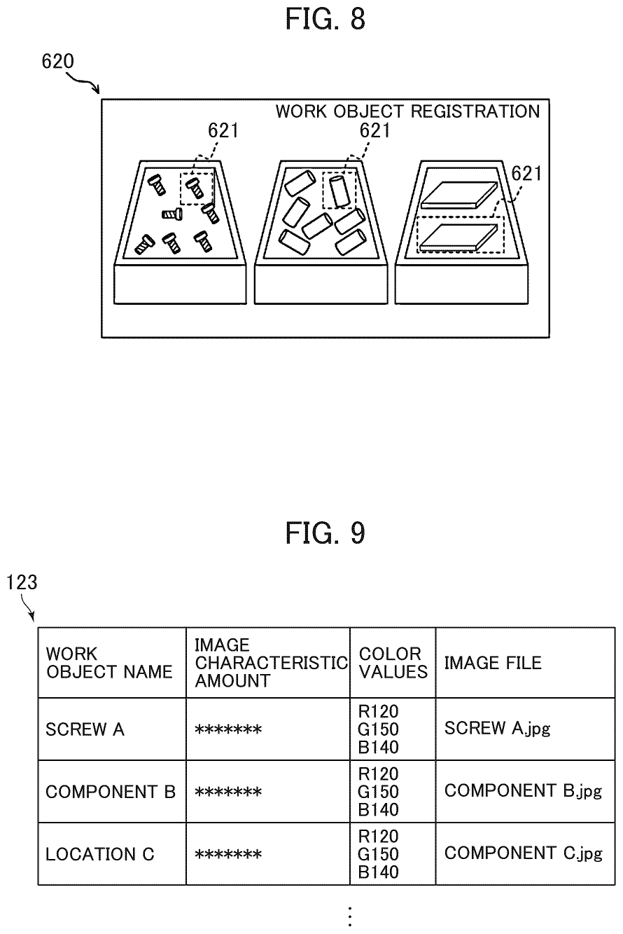

The work location registration processing (S11) and the work object registration processing (S12) that are performed in step S1 will be described with reference to FIGS. 6 and 8.

### (S11: Work Location Registration Processing)

FIG. 6 is a diagram illustrating an example of a work location registration screen 610 that is a screen for executing the processing in step S11 (work location registration processing).

In step S11, the work location of the robot 5 is recognized and information regarding the recognized work location is registered in the work location information 122. Specifically, the user specifies, via the input device 18 on the work location registration screen 610 illustrated in FIG. 6, the work location where the robot 5 may work, as indicated by a dashed square 611 on the work location registration screen 610. Thereafter, the user adds any name to the specified work location via the input device 18. In this case, the recognition unit 111 acquires, from an image corresponding to the specified work location, a numerical value of a dominant color of the work location that is information regarding the dominant color of the work location and a numerical value (brightness) that is information regarding brightness of the work location and indicates the brightness. The image may be the image acquired from the camera 2b illustrated in FIG. 1 or may be the image acquired from the camera 2a included in the robot hand 52 after the user operates the robot arm 51. The dominant color is, for example, a color that is most prominent in the image. In addition, the numerical value of the dominant color is, for example, a value (intensity) for each of red (R), green (G), and blue (B). Then, the recognition unit 111 registers, in the work location information 122, an image file of the specified work location, the added name, the acquired numerical value of the dominant color, and the numerical value indicating the brightness in association with each other.

The image used in step S11 is a single frame of the video captured by the camera 2. Alternatively, in a case where the camera 2 is capable of capturing video and a still image, a still image captured by the camera 2 may be used.

(work Location Information 122)

FIG. 7 is a diagram illustrating an example of the work location information 122.

As illustrated in FIG. 7, the work location information 122 includes items of “work location name”, “dominant color values”, “brightness”, and “image file”.

In the item field of “work location name”, a work location name that the user arbitrarily assigns to the work location is stored.

In the item field of “dominant color values”, numerical values of a dominant color acquired from the image of the work location are stored as RGB values.

In the item field of “brightness”, a numerical value indicating brightness acquired from the image of the work location is stored as brightness.

In the item field of “image file”, the name of a file of an image indicated by the dashed square 611 illustrated in FIG. 6 or a link to the file is stored.

As described above, the recognition unit 111 recognizes and quantizes, based on the image of the work location captured by the camera 2, information regarding the brightness of the work location and information regarding the dominant color of the work location. Then, the recognition unit 111 stores the quantized results to the work location information 122. By performing this, information for performing processing in the image processing described later can be acquired. The recognition unit 111 stores, to the work process support system, the name of the work location input by the user, the information regarding the brightness of the work location, and the information regarding the dominant color of the work location, while the name of the work location input by the user is associated with the information regarding the brightness of the work location and the information regarding the dominant color of the work location. By performing this, the information of the work location is easily managed.

### (S12: Work Object Registration Processing)

FIG. 8 is a diagram illustrating an example of a work object registration screen 620 that is a screen for performing processing in step S12 (work object registration processing).

In step S12, the work object to be handled in the work process is recognized and information regarding the recognized work process is stored in the work object information 123. Specifically, the user specifies the work object on the work object registration screen 620 illustrated in FIG. 8 via the input device 18, as in a dashed square 621 on the work object registration screen 620.

Thereafter, the user adds any name to a specified image (image of the work object) via the input device 18. The image may be acquired from the camera 2b illustrated in FIG. 1 or the like, or may be acquired from the camera 2a included in the robot hand 52 after the user may operate the robot, arm 51. In this case, the recognition unit 111 acquires an image characteristic amount regarding the image of the specified work object and a color value. Then, the recognition unit 111 registers, in the work object information 123, an image file of the specified work object, the added name, and the acquired color value in association with each other. As an algorithm for calculating the image characteristic amount, a known algorithm (deep learning or the like) may be used. In the present embodiment, it is assumed that information regarding complexity of the shape is obtained as the image characteristic amount. In a case where a large number of work objects of the same type are present, one of the work objects may be specified. For example, if a large number of screws of the same type are present, one of the screws may be specified.

The image used in step S12 is a single frame of the video captured by the camera 2. Alternatively, in a case where the camera 2 is capable of capturing video and a still image, a still image captured by the camera 2 may be used. Various methods for specifying the work object may be used.

### (Work Object Information 123)

FIG. 9 is a diagram illustrating an example of the work object information 123.

As illustrated in FIG. 9, the work object information 123 includes items of “work object name”, “image characteristic amount”, “color value”, and “image file”.

In the item field of “work object name”, a work object name to which that the user arbitrarily assigns to the work object is stored.

In the item field of “image characteristic amount”, a characteristic amount obtained from the image of the work object is stored.

In the item field of “color value”, numerical values of a color acquired from the image of the work object are stored as RGB values.

In the item field of “image file”, a file name of an image indicated by a dashed square 621 illustrated in FIG. 8 or a link to the file is stored.

As described above, the recognition unit 111 recognizes the color values and the image characteristic amount of the work object and stores the color values and the image characteristic amount to the work object information 123. By performing this, information for performing processing in the image processing described later can be acquired. The recognition unit 111 stores, to the work object information 123, the name of the work object input by the user, the color value of the work object, and the image characteristic amount, while the name of the work object input by the user is associated with the color value of the work object, and the image characteristic amount. By performing this, the information of the work object is easily managed.

In a case where the work location and the work object are already registered, the processing in step S1 can be omitted.

### <S2: Edit of Work Process Edit Region D2>

When the work operation in step S1 is completed, the user edits the work process edit region D2 displayed on the GUI screen D. In the description of the processing in step S2, FIG. 3 is referenced as appropriate.

### (S21: Addition of Work Definition Region D21)

First, the user presses the add button D25 via the input device 18 to add a work definition region D21. In the example illustrated in FIG. 3, two work definition regions D21 are set (work definition regions D21a and D21b). That is, the user can add an arbitrary number of operation unit setting regions D210 to the work definition region D21. For example, when the add button D25 is pressed in a state where the work definition region D21 is selected, an operation unit setting region D210 is added to the work definition region D21 being selected.

In the operation unit setting region D210, each of operations to be performed by the robot 5 in the work process is set. As described above, the operation unit setting region D210 includes elements of the operation content display region D211, the work object display region D212, and the work location display region D213. As described above, the operation unit setting region D210 includes the number-of-repetitions setting region D214 and the operation speed setting region D215.

### (Operation Information 121)

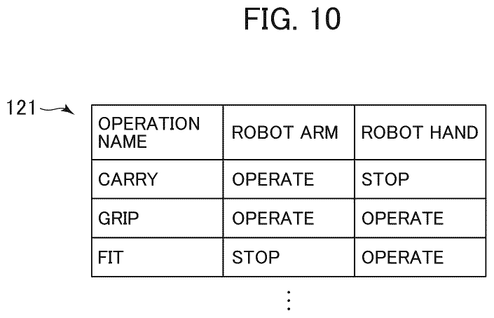

FIG. 10 is a diagram illustrating an example of the operation information 121.

As illustrated in FIG. 10, information regarding the operations is stored in the operation information 121. As in the example of the operation information 121 illustrated in FIG. 10, operation names, such as “carry” and “grip”, that are used for instruction of the work process of the robot 5 are stored. Operations of the robot arm 51 and the robot hand 52 that are components constituting the robot 5 are stored for each of the operation names in association with each other. For example, for the operation name “carry”, the robot arm 51 operates but the robot hand 52 stops operating.

As described above, in the operation information 121, information regarding the operations of the robot hand 52 and the robot arm 51 is stored for each operation name.

Operations stored in the operation information 121 are not limited to the example illustrated in FIG. 10, operations (“lifting”, “lowering”, and the like) corresponding to the hardware configuration of the robot 5 may be stored. In addition, the operation information 121 is set by the user in advance. Operational states (“stop”, “operate”, and the like) stored in the operation information 121 are not limited to character strings illustrated in FIG. 10, and may be stored with numerical values (operation IDs or the like), and a method for storing the information in the operation information 121 is not limited.

Since the operation information 121 is held in the database unit 120, an operation is easily set as described later.

### (S22: Setting of Operation)

The user presses the operation button D22 displayed on the GUI screen D to enable selection of an operation name stored in the operation information 121 illustrated in FIG. 10. The user selects one of the operation names that have become selectable via the input device 18, and thus an operation that corresponds to the selected operation name is set in the operation content display region D211 of the operation unit setting region D210.

### (S23: Setting of Work Object)

The user presses the work object button D23 to enable selection of the work object stored in the work object information 123. The user selects the work object that has become selectable, and thus the work object is set in the operation unit setting region D210. That is, the user selects, as the work object, any work object from among work objects registered in the work object information 123. In this manner, the work object is set in the work object display region D212 of the operation unit setting region D210.

### (S24: Setting of Work Location)

The user presses the work location button D24 to enable selection of the work location stored in the work location information 122. The user selects the work location that has become selectable and thus the work location is set in the work location display region D213 of the operation unit setting region D210. That is, the user specifies the work location registered in the work location information 122. In FIG. 3, two work locations are set in an operation unit setting region D210 indicated by “#1” of “work #1”, and one work location is set in each of other operation unit setting regions D210. Since an operation is “carry” in “#1” of “work #1”, the two work locations that are a location from which the work object is carried and a location to which the work object is carried are set. Meanwhile, in the other operation unit setting regions D210, operations are “fit”, “grip”, and “rotate” and do not require to carry the work object, and thus one work location is set.

### (S25: Setting of Operation Speed)

As described above, in the work definition region D21, an operation speed setting region D215 is displayed for each operation unit setting region D210. The user sets an operation speed in each operation speed setting region D215 via the input device 18.

### (S26: Setting of Number of Repetitions)

As described above, a number-of-repetitions setting region D214 is displayed for each work definition region D21 in the work definition region D21. The number of repetitions is the number of times the robot 5 repeats a series of control operations. The series of control operations is an operation set in the operation unit setting region D210 of the work definition region D21. For example, according to the example illustrated in FIG. 3, in the work definition region D21a, information indicating that operations from “#1” to “#2” in the operation unit setting regions D210 are repeated three times is set. In the work definition region D21b, a number-of-repetitions setting part indicates “−”. That is, in the work definition region D21b, the number of repetitions is not set. In other words, a control operation in the work definition region D21b is the operations from “#1” to “#2” in the operation unit setting region D210 are performed only once.

### (S27: Creation of Work Process Information 124: Association Definition Step)

When the processing in steps S22 to S26 is completed, the association definition unit 112 creates the work process information 124 based on the content set in the work process edit region D2, the work location information 122, and the work object information 123.

### (Work Process Information 124)

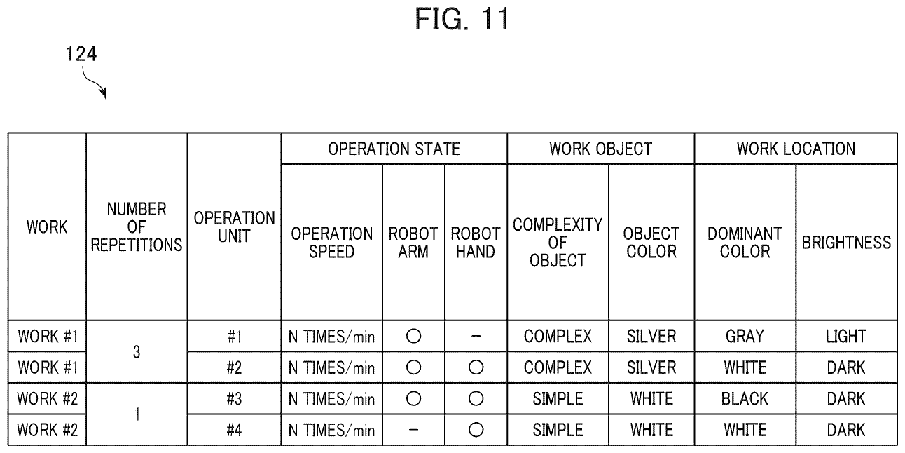

FIG. 11 is a diagram illustrating an example of the work process information 124.

Each information defined in the operation unit setting regions D210 (that is, the information set in steps S22 to S26 illustrated in FIG. 5) is stored in the work process information 124 by the association definition unit 112 for each operation unit setting region D210.

As illustrated in FIG. 11, the work process information 124 includes items of “work”, “number of repetitions”, “operation unit”, “operational state”, “work object”, and “work location”. The “operational state” includes items of “operation speed”, “robot arm”, and “robot hand”. The “work object” includes items of “complexity of object” and “object color”. The “work location” includes items of “dominant color” and “brightness”.

Information stored in the item field of “work” corresponds to the work definition region D21 illustrated in FIG. 3. In the example illustrated in FIG. 11, “work #1” corresponds to the work definition region D21a illustrated in FIG. 3, and “work #2” corresponds to the work definition region D21b illustrated in FIG. 3.

In the item field of “number of repetitions”, the number of repetitions set in the number-of-repetitions setting region D214 illustrated in FIG. 3 in step S26 illustrated in FIG. 5 is stored.

Information stored in the item field of “operation unit” corresponds to the operation unit setting region D210 illustrated in FIG. 3. “#1” in the item field of “operation unit” in the example illustrated in FIG. 11 corresponds to the operation unit setting region D210 “#1” illustrated in FIG. 3. The same applies to “#2” to “#4”.

In the item field of “operation speed” in “operation state”, an operation speed set in the operation speed setting region D215 illustrated in FIG. 3 in step S25 illustrated in FIG. 5 is stored.

Information stored in the item field of “robot arm” in the operation state is information regarding whether the robot arm 51 operates in the corresponding operation. In a case where the robot arm 51 operates, ○ is stored. In a case where the robot arm 51 stops operating, “−” is stored. The association definition unit 112 (see FIG. 4) refers to information set in the operation content display region D211 illustrated in FIG. 3 and the operation information 121 illustrated in FIG. 10, thereby storing information in the item field of “robot arm”. For example, “carry” is set as an operation in the operation unit setting region D210a illustrated in FIG. 3, and thus the association definition unit 112 refers to “carry” in “operation name” of the operation information 121 illustrated in FIG. 10. In the example of the operation information 121 illustrated in FIG. 10, the robot arm 51 indicates “operate” for “carry”. Therefore, the association definition unit 112 stores “○” in the item field of “robot arm” illustrated in FIG. 11.

In the item field of “robot hand” in the operational state, information indicating whether the robot hand 52 operates in the corresponding operation is stored. In a case where the robot hand 52 operates, “○” is stored. In a case where the robot hand 52 stops operating, “−” is stored. The association definition unit 112 (see FIG. 4) refers to information set in the operation content display region D211 illustrated in FIG. 3 and the operation information 121 illustrated in FIG. 10, thereby storing information in the item field of “robot hand”. For example, in the operation unit setting region D210a illustrated in FIG. 3, “carry” is set as an operation, and thus the association definition unit 112 refers to “carry” in “operation name” of the operation information 121 illustrated in FIG. 10. In the example of the operation information 121 illustrated in FIG. 10, the robot hand 52 indicates “stop” for “carry”. Therefore, the association definition unit 112 stores “−” in the item field of “robot hand” illustrated in FIG. 11.

In the item field of “complexity of object” of the work process information 124, information regarding complexity of the shape of the work object based on the image characteristic amount stored in the work object information 123 illustrated in FIG. 9 is stored.

In the item field of “object color”, information based on the color value of the work object stored in the work object information 123 illustrated in FIG. 9 is stored. The object color is the color of the work object.

The information stored in the item fields of “complexity of object” and “object color” is information stored in the work object information 123.

In the field of “dominant color” in “work location” of the work process information 124, information acquired by referring to the work location set in the work location display region D213 illustrated in FIG. 3 and the work location information 122 (see FIG. 7) is stored. Specifically, in the field of “dominant color” in “work location” of the work process information 124, information stored in the field of “dominant color” of the work location information 122 using the target work location as a key is stored. In addition, information (information regarding brightness) stored in the item field of “brightness” in “work location” of the work process information 124 is determined based on whether the brightness stored in the item field of “brightness” of the work location information 122 is greater than or equal to a predetermined value.

As described above, the information stored in the item fields of “dominant color” and “brightness” is information stored in the work location information 122.

### <S31: Creation of Image Processing Configuration Information 125: Control Processing Configuration Step>

When the verify image processing button D12 is pressed, the image processing configuration unit 113 selects image processing and stores a parameter necessary for the image processing to the image processing configuration information 125, based on information of the work process information 124. By performing this, the image processing configuration information 125 is created. The image processing in step S31 is processing performed on the video input from the camera 2 during the operation of the robot 5.

### (Image Processing Configuration Information 125)

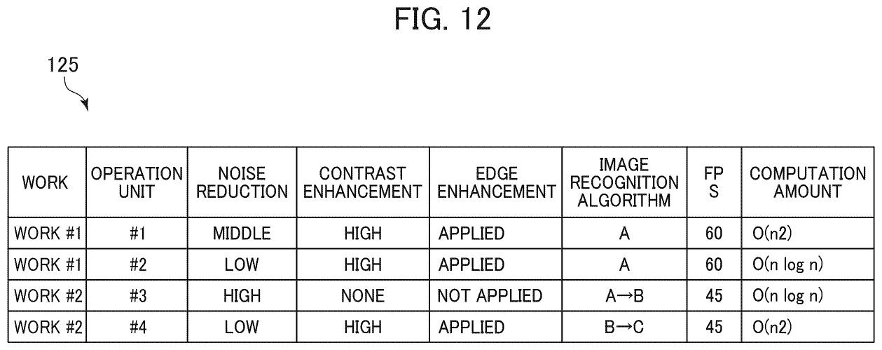

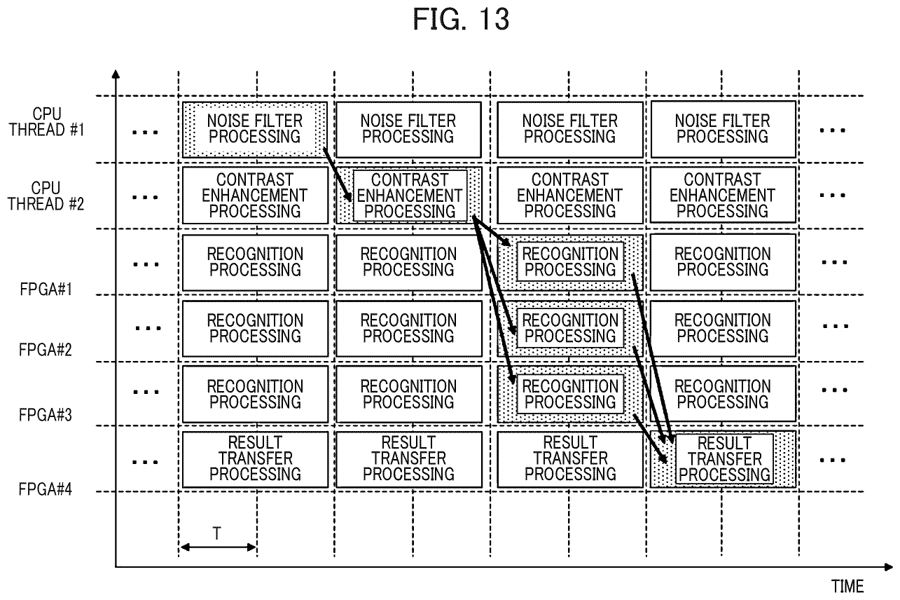

FIG. 12 is a diagram illustrating the image processing configuration information 125.

As illustrated in FIG. 12, the image processing configuration information 125 that is control processing configuration information stores information of “work”, “operation unit”, “noise reduction”, “contrast enhancement”, and “edge enhancement”. In the image processing configuration information 125, information of “image recognition algorithm”, “frames per second (FPS ”, and “computation amount” is stored.

Records of the image processing configuration information 125 correspond to the operation unit setting regions D210 illustrated in FIG. 3.

Information stored in the item field of “work” corresponds to the work definition region D21 illustrated in FIG. 3. In the example illustrated in FIG. 12, “work #1” corresponds to the work definition region D21a illustrated in FIG. 3, and “work #2” corresponds to the work definition region D21b illustrated in FIG. 3.

Information stored in the “operation unit setting regions” corresponds to the operation unit setting regions D210 illustrated in FIG. 3. “#1” in the item field of “operation unit” in the example illustrated in FIG. 12 corresponds to the operation unit setting region D210 “#1” illustrated in FIG. 3. The same applies to “#2” to “#4”.

“Noise reduction”, “contrast enhancement”, and “edge enhancement” are the processing (processing of each type that is performed in the image correction processing) constituting the image correction processing that is performed on the images input from the camera 2. The image correction processing that is “noise reduction”, “contrast enhancement”, and “edge enhancement” is performed by an image correction processing algorithm. As described above, the image correction processing is processing constituting the image processing. As described above, in the present embodiment, the image processing is constituted by the image correction processing and the recognition processing by the image recognition algorithm. In addition, information stored in the item fields of “noise reduction”, “contrast enhancement”, and “edge enhancement” is parameters to be used for the image processing.

As described above, in the image processing configuration information 125, a level of the processing of each type that constitutes the image correction processing and whether or not the processing is performed are stored. In “image recognition algorithm”, information regarding the image recognition algorithm that is used for recognizing the image of the work object and the image of the work location that have been input from the camera 2 is stored. In the present embodiment, the recognition processing is performed by the image recognition algorithm. In the recognition processing, for example, processing such as processing of extracting the work object from the images input from the camera 2 and performing contour enhancement is performed. By performing this, the user visibility can be improved. “FPS” is an abbreviation for “Frames per Second”, and is a frame rate of the video input to the controller 1. “Computation amount” is a computation amount required for “noise reduction”, “contrast enhancement”, “edge enhancement”, and the image recognition algorithm used. In the present embodiment, the image correction processing algorithm that performs the image correction processing, and the image recognition algorithm are collectively referred to as an image processing algorithm.

The image processing is performed for each of operation units set in the operation unit setting regions D210. That is, the image processing is performed in order from the top of the image processing configuration information 125 illustrated in FIG. 12. However, as illustrated in FIG. 3, “operation unit #1” and “operation unit #2” may be repeated three times.

First, the image processing configuration unit 113 determines a high or low level of the noise reduction based on the brightness of the work location. The high or low level (level) of the noise reduction is determined by referring to the item field of “brightness” of the work process information 124 illustrated in FIG. 11 using “operation unit” as a key. For example, in a case where “dark” is stored in the item field of “brightness” of the work process information 124, the image processing configuration unit 113 increases a threshold for the noise reduction to increase a pixel range in which the noise reduction is performed. That is, “high” is set in “noise reduction” in FIG. 12. As described above, information stored in the item field of “brightness” of the work process information 124 is information stored in the work location information 122. Therefore, the image processing configuration unit 113 determines the level of the noise reduction among the above-described parameters based on information of the brightness of the work location stored in the work location information 122.

Next, the image processing configuration unit 113 compares the object color of the work object in the work process information 124 with the dominant color of the work location in the work process information 124 and sets contrast adjustment and edge enhancement based on the difference between the color values. For example, in a case where the difference between the color values is small, the image processing configuration unit 113 sets the image contrast to be enhanced (“contrast enhancement: high” (level of contrast adjustment)). For example, in a case where the difference between the color values is small, the image processing configuration unit 113 sets the edge enhancement to be performed (edge enhancement: applied (whether the edge enhancement is applied)). As described above, the object color of the work object in the work process information 124 is information stored in the work object information 123, and the dominant color of the work location in the work process information 124 is information stored in the work location information 122. Therefore, the image processing configuration unit 113 determines the level of the contrast adjustment among the parameters based on the color difference between the object color of the work object stored in the work object information 123 and the dominant color of the work location stored in the work location information 122. Similarly, the image processing configuration unit 113 determines whether the edge enhancement is applied among the parameters based on the color difference between the object color of the work object stored in the work object information 123 and the dominant color of the work location stored in the work location information 122.

As the image correction processing algorithm that performs the image correction processing, a known algorithm may be used.

The image processing configuration unit 113 selects an image recognition algorithm according to the complexity of the object illustrated in FIG. 11. In general, image recognition algorithms are selectively used based on the complexity of the shape of the work object. For example, in a case where the work object has a simple shape, Histograms of Oriented Gradients (HOG) features are used. In a case where the work object has a complex shape, Scaled Invariance Feature Transform (SIFT) features or the like are used. The selected image recognition algorithm is stored in the item field of “image recognition algorithm” illustrated in FIG. 12. As the image recognition algorithm, deep learning or the like may be used. As described in the present embodiment, the method of selecting an image recognition algorithm based on the complexity of the shape of the work object is an example, and an image recognition algorithm may be selected based on other than the complexity of the shape. As described above, the complexity of the object illustrated in FIG. 11 is information based on the image characteristic amount of the work object stored in the work object information 123. Therefore, the image processing configuration unit 113 selects an image recognition algorithm based on the image characteristic amount of the work object stored in the work object information 123.

As illustrated in FIG. 12, the image processing configuration unit 113 sets, in the image processing configuration information 125 for each operation unit, an image processing algorithm necessary to recognize the work object and the work location and a parameter to be used for the image processing, based on the work location information 122 and information stored in the work object information 123. Specifically, the image processing configuration unit 113 stores, to the image processing configuration information 125 for each operation unit, set the level of the noise reduction, the level of the contrast adjustment, whether the edge enhancement is applied, and the selected image recognition algorithm. Since the image processing configuration information 125 described above is created, the amount of subsequent computation is easily calculated.

Further, the image processing configuration unit 113 calculates a computation amount required for the image processing based on the information stored in the image processing configuration information 125. That is, the image processing configuration unit 113 calculates a computation amount required for the selected image correction processing algorithm and the selected image recognition algorithm. Since a known technique is used for each of the image correction algorithm and the image recognition algorithm, the computation amount is easily calculated. The image processing configuration unit 113 stores the calculated computation amount in the field of “computation amount” in the image processing configuration information 125. Since the computation amount is calculated, computation mapping described later is easy.

### <S32: Setting of Optimization Option>

After step S31 is completed, the user sets an optimization option in the processing mode edit region D3 illustrated in FIG. 3. In step S32, the user presses any one of optimization option buttons displayed on the GUI screen D illustrated in FIG. 3 to specify an optimization option to be prioritized for implementation of the image processing in the controller 1. As indicated in the processing mode edit region D3 in FIG. 3, for example, the user selects “performance” as a type of optimization option and presses the verify image processing button D12 via the input device 18.

In the processing mode edit region D3 illustrated in FIG. 3, the user can specify a criterion by which the image processing of the robot 5 is to be optimized. As illustrated in FIG. 3, as a criterion (optimization option) for efficiency, information including “performance”, “real-time performance”, “resource”, and “power consumption” is present. “Performance” refers to optimization to maximize the execution performance of the image processing (control processing). “Real-time performance” refers to optimization to secure real-time performance during the execution of the image processing. The real-time performance during the execution of the image processing (control processing) indicates that any processing is necessarily completed within a specific period of time. The “resource” refers to optimization to minimize the computing resources during the execution of the image processing (control processing). “Power consumption” refers to optimization to minimize power consumption of the controller 1 during the execution of the image processing (control processing). One optimization option may be selected or a plurality of optimization options may be selected.

### <S33: Computation Mapping: Processing Optimization Step>

After the creation of the image processing configuration information 125 is completed, the processing optimization unit 114 determines a processing mode of the image processing based on the optimization option and the information stored in the image processing configuration information 125. As described above, the processing mode refers to assignment to the computing resources indicated in (A1) and a time schedule indicated in (A2). Performing the assignment to the computing resources and making the time schedule are referred to as computation mapping.
(A1) The assignment of the processing of each type constituting the image processing to the computing resources.
(A2) A computation cycle for the processing of each type constituting the image processing and a time schedule for each computation cycle.

As described above, the processing optimization unit 114 performs the computation mapping to determine information for the above-described (A1) and (A2). That is, the processing optimization unit 114 performs the computation mapping to determine the assignment of the processing of each type constituting the image processing to the computing resources and a time schedule for the processing of each type based on the priority item and the computation amount.

### <S34: Output: Processing Optimization Step>

After step S33, the processing optimization unit 114 outputs a result of the computation mapping to the display device 3. In step S33, for example, information illustrated in FIGS. 13 to 16 is output to the display device 3.

### (Specific Example of Result of Computation Mapping)

With reference to FIGS. 13 to 15, an example of the result of the computation mapping will be described.

In the following description, for the convenience of explaining the example of the result of the computation mapping, the image processing is limited to noise filter processing, contrast enhancement processing, and recognition processing of images input from the cameras 2a and 2b illustrated in FIG. 1. The recognition processing is image recognition processing by the image recognition algorithm. As described above, the images are video images.

It is assumed that amounts consumed in the noise filter processing, the contrast enhancement processing, and the recognition processing in a computation cycle are “2”, “2”, and “6”, respectively. In addition, it is assumed that the noise filter processing, the contrast enhancement processing, and the recognition processing are performed in the order of the noise filter processing, the contrast enhancement processing, and the recognition processing in all cycles. The noise filter processing is a processing of removing noise. That is, since the noise filter processing, the contrast enhancement processing, and the recognition processing are performed on the images input from the camera 2, the visibility of the images is improved when the user operates the robot 5. After the recognition processing, result transfer processing is performed to transfer results of the noise filter processing, the contrast enhancement processing, and the recognition processing to the display device 3. In addition, it is assumed that available computing resources are threads (CPU threads) of the CPU 11 and the FPGAs 12.

### (Case Where “Performance” is Selected as Optimization Option)

FIG. 13 is a diagram illustrating an example of a result of computation mapping when the “performance” is selected as an optimization option.

In FIG. 13, the vertical axis indicates the number of types of processing deployed to the computing resources, and the horizontal axis indicates elapsed time. FIG. 13 illustrates a case where the number of CPU threads (CPU threads #1 and #2) is two and the number of FPGAS 12 (FPGAS #1 to #4) to be used is four. In FIGS. 13 to 16, a computation cycle T is a minimum unit of processing performed in the CPU 11 and the FPGAs 12.

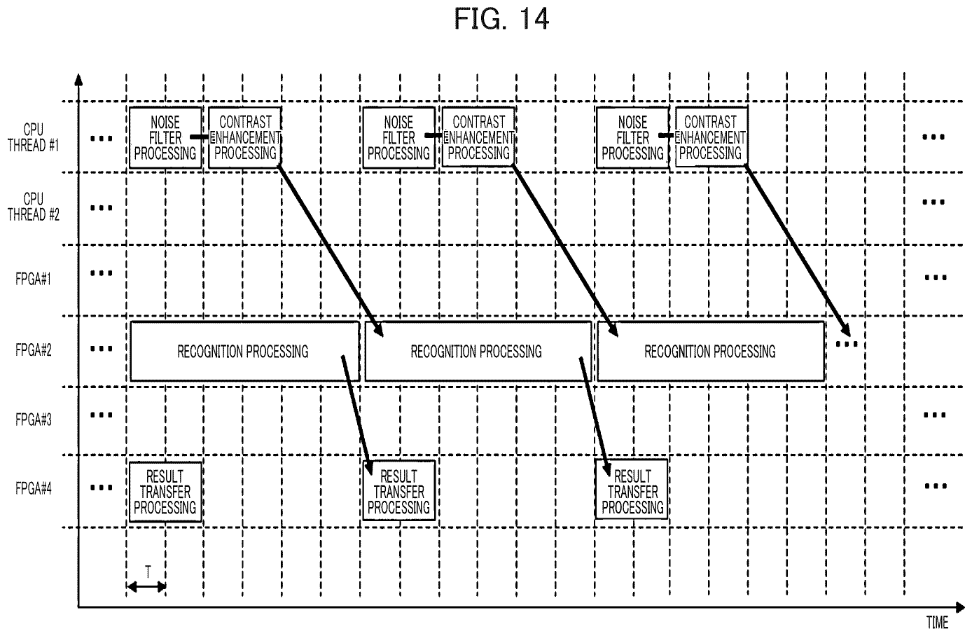

When “performance” is selected as an optimization option, the processing of each type is assigned to all of the available computing resources in parallel, and thus the computation mapping is performed such that the control speed is maximized. The processing of each type is the noise filter processing, the contrast enhancement processing, the recognition processing, and the result transfer processing. While the processing of each type is performed in parallel, a plurality of types of processing cannot be performed on a single image at the same time. That is, the noise filter processing, the contrast enhancement processing, and the recognition processing cannot be simultaneously performed on the same image. Therefore, it is necessary to perform the processing of each type on the single image in sequence. The single image is an image of one frame in the video. That is, in FIG. 13, the CPU 11 and the FPGAs 12 perform the noise filter processing, the contrast enhancement processing, the recognition processing, and the transfer processing on each frame of the images constituting the video. The same applies to FIGS. 14 to 16.

A data flow for a certain single image input from the actual camera 2 is indicated in a dot part in FIG. 13. Thick arrows indicate the flow of the image processing for the input image. Image processing other than the dot part is image processing on a previously input image and processing on a next image. As described above, while the processing of each type is sequentially performed on each image, an image at another point of time is processed in parallel. Therefore, the computing resources can be efficiently used. In a case where “performance” is selected as the optimization option, it is desirable that the computation cycle T be set as a settable shortest cycle and that the number of images to be processed per unit time in the image processing be increased. Note that before the computation mapping, the processing optimization unit 114 sets the computation cycle T. Therefore, the processing when each optimization option is selected is easily managed. As illustrated in FIG. 13, the processing optimization unit 114 synchronizes the timing of the processing of each type as one unit of the computation cycle T.

### (Case Where “Resource” is Selected as Optimization Option)

FIG. 14 is a diagram illustrating an example of a result of computation mapping in a case where “resource” is selected as an optimization option.

In FIG. 14, the vertical axis indicates the number of types of processing deployed to the computing resources, and the horizontal axis indicates elapsed time. Thick arrows indicate the flow of the image processing for the input image. In a case where the optimization option is resource, the noise filter processing and the contrast enhancement processing that require small amounts of computation are assigned to software for the CPU 11 or the like. In addition, the noise filter processing and the contrast enhancement processing that are assigned to the CPU 11 are serially performed in the same thread. The recognition processing and the result transfer processing that require large amounts of computation are implemented in hardware such as the FPGAs 12. By performing this, it is possible to perform the processing of each type with only the minimum computing resources (resources) while the minimum performance is secured. In a case where power consumption is to be reduced, it is possible to suppress power consumption of the controller 1 by increasing the computation cycle T (in a case where “power consumption” is selected as an optimization option).

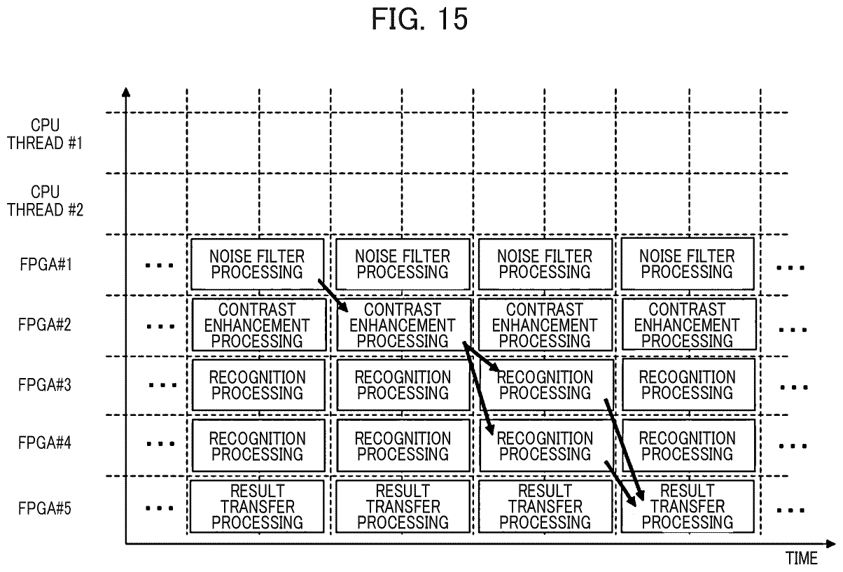

(Case Where “Real-time Performance” is Selected as Optimization Option) FIG. 15 is a diagram illustrating an example of a result of computation mapping in a case where “real-time performance” is selected as an optimization option.

FIG. 15 illustrates a case where the number of CPU threads (CPU threads #1 and #2) is two and the number of FPGAS 12 (FPGAS #1 to #5) to be used is 5. In addition, amounts consumed in the noise filter processing, the contrast enhancement processing, and the recognition processing in the computation cycle T are “2”, “2”, and “4”, respectively. Further, it is assumed that the noise filter processing, the contrast enhancement processing, and the recognition processing are performed in the order of the noise filter processing, the contrast enhancement processing, and the recognition processing in all cycles.

As described above, the real-time performance in the image processing indicates that any processing is necessarily completed within a specific period of time. In this case, the requirement can be achieved automatically in a case where “performance” is selected as the optimization option in some cases. That is, when “performance” is selected as the optimization option, “real-time performance” may also be achieved.

Meanwhile, in FIG. 15, all of the image processing is performed in the FPGAs 12 differently from FIG. 13. As illustrated in FIG. 15, all of the image processing is a processing by hardware such as the FPGAS 12, and thus respective operational clocks can be aligned. Therefore, it is possible to improve the accuracy of securing the real-time performance per operational clock unit in each computation cycle T.

In the first embodiment, the setting of the work process of the robot 5 using the GUI screen D as illustrated in FIG. 3 and the computation mapping as illustrated in FIGS. 13 to 15 are performed. Therefore, it is possible to improve the efficiency of controlling the individual robot 5. That is, it is possible to support the setting of the work process to be performed by the robot 5 and appropriate setting of the image processing (control processing) necessary for operating the robot 5.

In addition, by setting the work process of the robot 5 using the GUI screen D as illustrated in FIG. 3, the user can easily set the work process of the robot 5.

As illustrated in FIGS. 13 to 15, the robot operation system Z deploys various types of processing and related processing associated with it based on the number of deployments to the computing resources, the number and length of computation cycles T consumed, that is, in units of time, and sets a time schedule. By performing this, it is possible to secure performance with a relatively simple method. In addition, according to the first embodiment, since the computation mapping is performed, it is possible to secure performance corresponding to the content of the work operation, that is, to optimize the efficiency of controlling the individual robot 5 according to the content of the work operation.

In addition, the robot operation system Z as illustrated in FIG. 1 enables the user to easily remotely support the robot 5 to support the work process.

In the first embodiment, a selected optimization option is assumed to be applied to all of the operation unit setting regions D210, but an optimization option may be set for each of the operation unit setting regions D210. This is due to the fact that it is possible to assume cases where the accuracy of the work operation and the work operation speed required for the robot 5 differ for each of the operation unit setting regions D210. For example, in a case where the user wants to quickly operate the robot 5, processing may be delayed if the image processing is not performed at a high speed. By applying the computation mapping to the image processing, the image processing can be performed at a high speed depending on the configuration of the computing resources, and the user can prevent the image processing from being delayed during the remote operation of the robot 5.

### Second Embodiment

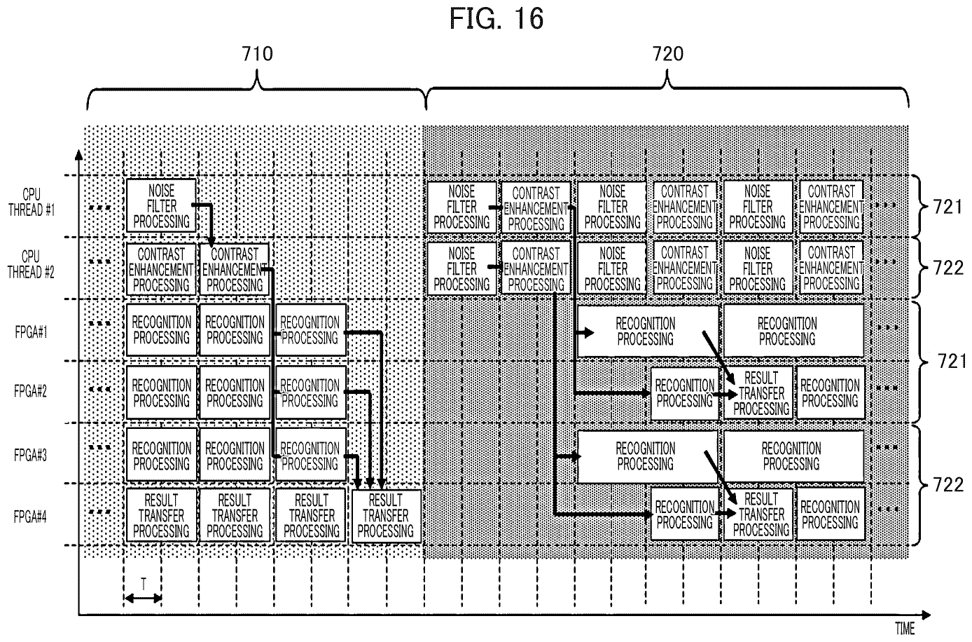

FIG. 16 is a diagram illustrating an example of a result of computation mapping according to a second embodiment.

The vertical axis and the horizontal axis in FIG. 16 are the same as those in FIGS. 13 to 15. In the example illustrated in FIG. 16, it is assumed that “performance” is selected as an optimization option.

In the second embodiment, a case where information of a plurality of cameras 2 is associated with operation unit setting regions D210. FIG. 16 illustrates results of computation mapping in a case where images captured by the plurality of cameras 2 are present in the robot operation system Z illustrated in FIG. 1.

In FIG. 16, thick arrows indicate the flow of processing relating to a certain image. In FIG. 16, a reference sign 710 refers to processing by a certain operation unit setting region D210, a reference sign 720 refers to processing by another operation unit setting region D210 different from the operation unit setting region D210 corresponding to the reference sign 710. In the example illustrated in FIG. 16, the processing of the different operation unit setting regions D210 is performed in the first and second halves. That is, in the example illustrated in FIG. 16, the processing of the operation unit setting regions D210 is separated by time. Processing that is not performed is present at a time close to a boundary between the reference sign 710 and the reference sign 720. This is due to the fact that the reference sign 710 is immediately before the end and that processing that has not ended within the range of the reference sign 710 is not performed. Similarly, the reference sign 720 has just started, and therefore processing that is preceded by processing (such as the contrast enhancement processing for the recognition processing) that has not been performed cannot be performed.

In the example illustrated in FIG. 16, in the reference sign 710, processing relating to an image input from one of the cameras 2 is performed. Then, in the reference sign 720, processing relating to images input from the two cameras 2 is performed. In addition, in the reference sign 720, a reference sign 721 refers to processing by one of the cameras 2, and a reference sign 722 refers to processing by the other of the cameras 2. Each of these cameras 2 is any one of the cameras 2a and 2b illustrated in FIG. 1.

As illustrated in FIG. 16, in the reference sign 710, computation mapping similar to the processing illustrated in FIG. 13 is performed. Then, in the reference sign 720, computing resources are equally distributed for the one of the cameras 2 and the other of the cameras 2, and the computation mapping is performed using all of the computing resources.

Comparing the processing in the reference sign 710 with the processing in the reference sign 720, the computation cycle T consumed in the processing of each type in the reference sign 720 becomes larger. That is, the processing time is extended. That is, in the reference sign 720, noise filter processing and contrast enhancement processing are serially performed. In addition, in the reference sign 720, the number of computation cycles T consumed for recognition processing is “4”, that is, a computation cycle T that is twice a computation cycle T for recognition processing in the processing of the reference sign 710 is consumed. However, in the reference sign 720, the processing of each type (reference sign 721) on the image input from the one of the cameras 2 and the processing of each type (reference sign 722) on the image input from the other of the cameras 2 are performed in parallel.

FIG. 16 illustrates the computation mapping for the two cameras 2, but similar computation mapping can be performed for three or more cameras 2. As described above, in the second embodiment, the processing optimization unit 114 determines different assignments and time schedules for the plurality of imaging devices.

Since the above-described computation mapping is performed, in a case where support by the plurality of cameras 2 is required, the computation mapping as described with reference to FIG. 16 can be performed.

The present invention is not limited to the embodiments described above, and includes various modifications. For example, the above-described embodiments have been described in detail in order to facilitate the understanding of the present invention, and the present invention is not necessarily limited to those including all of the described configurations. In addition, part of the configuration of one embodiment can be replaced with the configuration of the other embodiment, and the configuration of the one embodiment can also be added to the configuration of the other embodiment. In addition, part of the configuration of each of the embodiments can be subjected to addition, deletion, and replacement with respect to the other configurations.

In the present embodiment, the image processing is subjected to the computation mapping, but the computation mapping is not limited thereto. For example, processing relating to the operation of the robot 5 may be subjected to the computation mapping.

The above-described configurations and functions, the recognition unit 111 to the processing optimization unit 114, the operation information 121 to the image processing configuration information 125, and the like may be partly or entirely implemented in hardware by designing using an integrated circuit, for example. In addition, as illustrated in FIG. 2, the above-described configurations, functions, and the like may be implemented in software by a processor such as the CPU 11 interpreting and executing a program that implements each of the functions. The program that implements each of the functions, the information, and information such as the file can be stored in a recording device such as the memory 14 or a solid state drive (SSD) or a recoding medium such as an integrated circuit (IC) card, a secure digital (SD) card, a digital versatile disc (DVD), in addition to being stored in a hard disk (HD).

In addition, in each of the embodiments, the control lines and information lines that are considered necessary for the explanation are described, and not all the control lines and information lines on the product are necessarily described. Actually, almost all configurations are considered to be interconnected.

### List of Reference Signs

1: controller
2, 2 a, 2b: camera (imaging device)
3: display device
4: operation handle
5: robot
11: CPU
12: FPGA
17: auxiliary storage
18: input device
51: robot arm
52: robot hand
110: processing unit
111: recognition unit
112: association definition unit
113: image processing configuration unit (control processing configuration unit)
114: processing optimization unit
120: database unit (storage unit)
121: operation information
122: work location information
123: work object information
124: work process information
125: image processing configuration information (control processing configuration information)
610: work location registration screen
611: dashed square
620: work object registration screen
621: dashed square
D: GUI screen
D1: utility region
D2: work process edit region
D3: processing mode edit region
D11: recognize work button
D12: verify image processing button
D21: work definition region
D22: operation button
D23: work object button
D24: work location button
D25: add button
D210: operation unit setting region
D211: operation content display region
D212: work object display region
D213: work location display region
D214: number-of-repetitions setting region
D215: operation speed setting region
Z: robot operation system (work process support system)
S1: work location/work object registration processing (recognition step)
S27: creation of work process information (association definition step)
S31: creation of image processing configuration information (control processing configuration step)
S33: computation mapping (processing optimization step)
S34: output (processing optimization step)

1. A work process support system comprising:
a recognition unit that acquires work location information that is information regarding a work location of a robot, and work object information that is information of a work object;
an association definition unit that, when a work process of the robot is created, associates the work process with the work location information and the work object information;
a control processing configuration unit that determines a configuration of control processing for the robot based on the association by the association definition unit and calculates a computation amount in the control processing; and
a processing optimization unit that determines, based on the computation amount and a priority item selected by a user, assignment of processing to a computing resource for processing to be performed in the work process and outputs a result of the assignment.

2. The work process support system according to claim 1, wherein
a GUI screen that is a user interface is displayed on a display device, and
a series of operations to be performed by the robot is set by the user operating the GUI screen.

3. The work process support system according to claim 1, wherein
the recognition unit recognizes and quantifies, based on an image of the work location captured by an imaging device, information regarding brightness of the work location and information regarding a dominant color of the work location, and stores the quantified results to the work location information.

4. The work process support system according to claim 1, wherein
the recognition unit recognizes a color value and an image characteristic amount of the work object and stores the color value and the image characteristic amount to the work object information.

5. The work process support system according to claim 1, wherein
operation information in which information regarding an operation of a component constituting the robot is associated with an operation name to be used for instruction of the work process is held in a storage unit.

6. The work process support system according to claim 2, wherein
a work process edit region in which the work process is settable is displayed on the GUI screen,
operation units constituting the work process are settable by the user in an operation unit setting region displayed in the work process edit region,
in the work process edit region, for each of the operation units, the operation to be performed by the robot, the work object on which the operation is to be performed, and the work location where the operation is to be performed are set by the user, and an operation speed of the operation to be performed by the robot is settable, and
a number of times the work process set in the work process edit region is repeated is settable by the user.

7. The work process support system according to claim 1, wherein
the control processing includes image processing of processing an image input from an imaging device, and
the control processing configuration unit sets
an image processing algorithm necessary for recognizing the work object and the work location, and parameters to be used for the image processing in control processing configuration information for each operation unit based on the work location information and the information stored in the work object information.

8. The work process support system according to claim 7, wherein
the control processing configuration unit
determines a level of noise reduction among the parameters based on information regarding brightness of the work location stored in the work location information,
determines a level of contrast adjustment and whether edge enhancement is applied among the parameters based on a color difference between an object color of the work object stored in the work object information and a dominant color of the work location stored in the work location information,
selects an image recognition algorithm based on an image characteristic amount of the work object stored in the work object information, and
stores the determined level of the noise reduction, the determined level of the contrast adjustment, whether the edge enhancement is applied, and the selected image recognition algorithm to the control processing configuration information for each of the operation units.

9. The work process support system according to claim 7, wherein
the control processing configuration unit calculates
a computation amount required in the image processing based on information stored in the control processing configuration information.

10. The work process support system according to claim 9, wherein
the processing optimization unit determines
assignment of processing of each type constituting the image processing to a computing resource and a time schedule for the processing of each type based on the priority item and the computation amount.

11. The work process support system according to claim 10, wherein
the processing optimization unit determines
assignment and time schedules different for each of a plurality of imaging devices.

12. The work process support system according to claim 1, wherein
the priority item is selected from information including
performance that maximizes execution performance of the control processing,
a resource that minimizes a computing resource during execution of the control processing,
real-time performance during the execution of the control processing, and
power consumption that minimizes power consumption of a controller during the execution of the control processing.

13. The work process support system according to claim 1, wherein
the robot includes a robot arm and a robot hand,
the work process support system further comprises:
an imaging device;
a controller that controls the robot arm and the robot hand;
an operation handle for operating the robot arm and the robot hand; and
a display device that displays an image captured by the imaging device, and
the robot arm and the robot hand operate based on an input via the operation handle.

14. A work process support method causing a work process support system to execute:
a recognition step of acquiring work location information that is information regarding a work location of a robot and work object information that is information of a work object;
an association definition step of, when a work process of the robot is created, associating the work process with the work location information and the work object information;
a control processing configuration step of determining a configuration of control processing for the robot based on the association by the association definition step and calculating a computation amount in the control processing; and
a processing optimization step of determining, based on the computation amount and a priority item selected by a user, assignment of processing to a computing resource for the processing to be performed in the work process and outputting a result of the assignment.
